(19) United States
(12) Patent Application Publication
(10) Pub. No.: US 2024/0318720 A1
(43) Pub. Date: Sep. 26, 2024

(54) Locking Mechanism, Park Lock And Vehicle

(71) Applicant: Vitesco Technologies GmbH, Regensburg (DE)

(72) Inventor: Karl Martin Fritsch, Frankfurt (DE)

(73) Assignee: Vitesco Technologies GmbH, Regensburg (DE)

(21) Appl. No.: 18/731,172

(22) Filed: May 31, 2024

Related U.S. Application Data
(63) Continuation of application No. PCT/EP2022/083914, filed on Nov. 30, 2022.

(30) Foreign Application Priority Data
Dec. 2, 2021 (DE) 10 2021 213 738.5

(51) Int. Cl. F16H 63/34

(52) U.S. Cl. CPC F16H 63/3441; F16H 63/3466

(57) ABSTRACT

The disclosure provides a locking mechanism for a vehicle. Between a locking actuator and a rotatable, lockable element with a recess, into which an actuable form-fitting element FE of the locking actuator can be moved in portions in a form-fitting manner in an axial stroke movement in order to lock the element.

### CROSS-REFERENCE TO RELATED APPLICATIONS

This application claims the benefit of PCT Application PCT/EP2022/083914, filed Nov. 30, 2022, which claims priority to German Application 10 2021 213 738.5, filed Dec. 2, 2021. The disclosures of the above applications are incorporated herein by reference.

### TECHNICAL FIELD

The disclosure relates to a locking mechanism, a parking lock, and a vehicle.

### SUMMARY

The disclosure provides a compact and low-cost locking mechanism for a vehicle. The disclosure also provides an improved locking mechanism a vehicle.

One aspect of the disclosure provides a locking mechanism for a vehicle or a parking lock of a vehicle, between a locking actuator and a rotatable, lockable element with at least one recess or opening, into which an actuable form-fitting element of the locking actuator can be moved in portions in a form-fitting manner in an axial stroke movement in order to lock the element.

The locking actuator preferably has, outside a form-fitting region between the form-fitting element and the lockable element, a degree of freedom of movement for the form-fitting element relative or transverse to the axial stroke movement of the form-fitting element and up to an assigned stop, up to which the form-fitting element is deflectable or movable during a locking process and after the end of the locking process.

As a result of this degree of freedom of movement of the form-fitting element up to the stop, positioning inaccuracies between the form-fitting element and the recess are balanced out on one hand during the locking process.

On the other hand, as a result of this degree of freedom of movement of the form-fitting element up to the stop, dynamic torque loads in the form of torque peaks of a drivetrain are dissipated both during the locking process and also in particular after the end of the locking process.

Such torque peaks are expressed in relation to the locking mechanism in the form of shock loads which act on the locking actuator and its form-fitting element.

The stop absorbs torque loads of this type, or residual torque loads, which are possibly not entirely or not completely dissipated via this degree of freedom of movement of the form-fitting element up to the stop during the locking process or in particular after the end of the locking process in the form of the above-mentioned shock loads and introduces these shock loads at a suitable point into a periphery of the locking actuator. This involves a point of a periphery of a drivetrain, in particular of a vehicle.

Even greater positioning and/or alignment inaccuracies during the joining process and/or the locking process between the form-fitting and/or joining elements can be balanced out in an installation space-saving, energy-saving and low-cost manner via this proposed degree of freedom of movement of the locking mechanism. And energy-saving in particular when, during joining, only the form-fitting element of the locking actuator and not also the element to be locked of the drivetrain and and thus also the drivetrain is moved.

Moreover, in particular in the locked state of the element, dynamic load peaks in the form of torque peaks, as described above, are ideally entirely dissipated via the degree of freedom of movement, i.e. even before the form-fitting element reaches the stated stop.

At least, however, an impact load which acts on the form-fitting region between the form-fitting element and the lockable element is significantly reduced and correspondingly transferred to the stop outside the form-fitting region.

The stop can be embodied in such a manner that it, to absorb force, is supported at a suitable point of a periphery of a drivetrain, for example, on a housing of a drive unit with an electric motor and a (reduction) gear. The stop can be supported on a housing portion of an electric motor housing or a (reduction) gear housing.

As a result of the provision or implementation of a stop of the form-fitting element outside the form-fitting region between the form-fitting element and the lockable element, an installation space, available on the actuator side, of a periphery of a drivetrain can advantageously be optimally exploited and used.

In one embodiment, the form-fitting element has a first form-fitting element portion which can be joined for the form fit with a tapering in the region of its free end as well as a second form-fitting element portion which is wider in comparison with the first form-fitting element portion—in relation to the longitudinal extent of the form-fitting element or lengthwise to the form-fitting element—and which interacts with the stop provided outside the form-fitting region in order to dissipate the above-mentioned torque peaks. If the tapering of the first form-fitting element interacts with the recess or opening, the second form-fitting element portion is deflectable or movable transversely to the axial stroke movement of the form-fitting element and up to against this assigned stop of the locking actuator.

This deflection is enabled by play between the second form-fitting element portion and this stop or by play of the second form-fitting element portion relative to this stop.

This play enables the above-mentioned degree of freedom of movement outside the form-fitting region between the form-fitting element and the recess or opening and transverse to the axial stroke movement of the form-fitting element.

In a further embodiment, the form-fitting element can be deflected against the stop acting counter to at least one spring. This spring can be arranged between the form-fitting element or the second form-fitting element portion and the stop. In the unjoined state of the form-fitting element, i.e. if the form-fitting element is located outside the recess or opening of the lockable element, this at least one spring acts in a returning manner into a starting position of the form-fitting element relative to the stop, described above, of the locking actuator.

In a further embodiment, the form-fitting element is electrically actuable. Here, the axial stroke movement of the form-fitting element can be converted, for example, via an electromotorically driven screw drive which converts a rotational movement of an electric motor into a translational or linear movement. Alternatively, the axial stroke movement of the form-fitting element can also be generated by means of what is known as a plunger coil which, depending on the embodiment, can generate linear or rotary movements.

A parking lock for a vehicle having a locking mechanism of the type described above is also proposed and placed under protection (claim 7).

A vehicle having such a parking lock or a locking mechanism of the type described above is also proposed and placed under protection (claim 8).

A vehicle is to be understood to mean any type of vehicle or motor vehicle that is operated by an electric motor, but in particular passenger motor cars and/or utility vehicles. These are preferably partially autonomously and in particular fully autonomously operated vehicles.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a locking mechanism;

FIG. 2 shows a proposed, improved locking mechanism;

FIG. 3 shows the locking mechanism shown in FIG. 2 in a further illustration; and

FIG. 4 shows a shaft with recesses for such a locking mechanism.

Like reference symbols in the various drawings indicate like elements.

### DETAILED DESCRIPTION

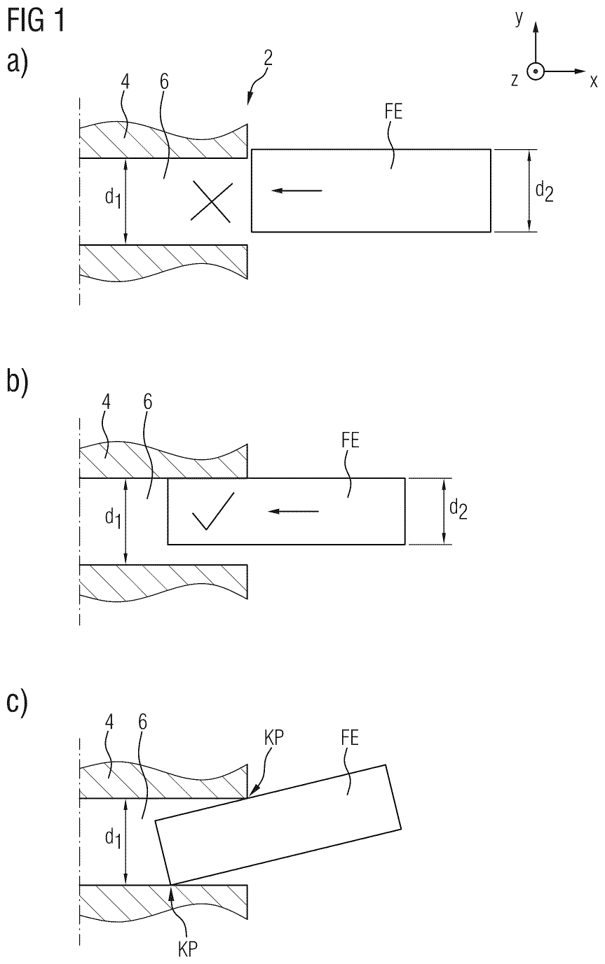

FIG. 1 illustrates a locking mechanism 2 between a locking actuator and a rotatable, lockable element 4 with a recess 6, into which an electrically actuable form-fitting element FE of the locking actuator can be moved in portions in a form-fitting manner in an axial stroke movement in order to lock the element 4. This locking mechanism is based on a parking lock of a vehicle.

In a parking position of the vehicle in which the vehicle is stationary, the form-fitting element FE can engage in the recess 6 or be actuated into the recess 6 in order to lock or block the element 4 and thus the vehicle, for example, in response to a desire of a driver who activates the parking lock.

In some implementations, the form-fitting element FE has the configuration of a locking bolt, with, for example, a circular cross-section, and the recess 6 the configuration of a hole, for example, circular hole, wherein the hole can be formed as a blind or through hole. The hole 6 is shaped in a lockable element 4 in the configuration of a shaft which transmits a torque. Such a hole 6 can be provided longitudinally or transversely to the longitudinal extent of the shaft 4.

Whether a locking of the element 4 in a parking position of the vehicle can be carried out depends on a positioning or alignment of the recess 6 relative to the form-fitting element FE in this parking position and from what is known as a tolerance position which balances out positioning or alignment inaccuracies between the joining elements FE, 4.

FIG. 1a) illustrates a tolerance position which does not enable a joining of the joining elements FE, 4. In contrast, the tolerance position according to FIG. 1b) enables their joining because the play on which it is based or the tolerance on which it is based is selected to be sufficiently large. In these two FIGS. 1a) and 1b), the form-fitting element FE is aligned in each case parallel to the wall of the recess 6.

FIG. 1c) illustrates a joining in the case of which the form-fitting element FE is tilted with respect to the recess 6. For this purpose, for example, a shaft 4 is imagined on which a hole 6 is formed transversely to its longitudinal extent and into which the form-fitting element FE engages.

The worse or more inaccurate an alignment of the recess 6 relative to the form-fitting element FE, the greater the stated play or the stated tolerance between the dimensions of the recess 6 (for example, diameter d₁ of the hole 6) and the dimensions of the form-fitting element FE (for example, diameter d₂ of the locking bolt FE) also must be in order to move the form-fitting element FE into the recess 6 and thus be able to bring about the form fit.

Depending on how poor or inaccurate this alignment is, joining arises in the case of which the form-fitting element FE is tilted to a greater or lesser extent with respect to the recess 6. Different edge pressures KP correspondingly arise between the joining elements 4, FE depending on the degree of tilting or depending on the extent of the tilting. The greater the tilting, the shorter distance the form-fitting element FE protrudes in the recess 6 and the greater the stated edge pressures KP.

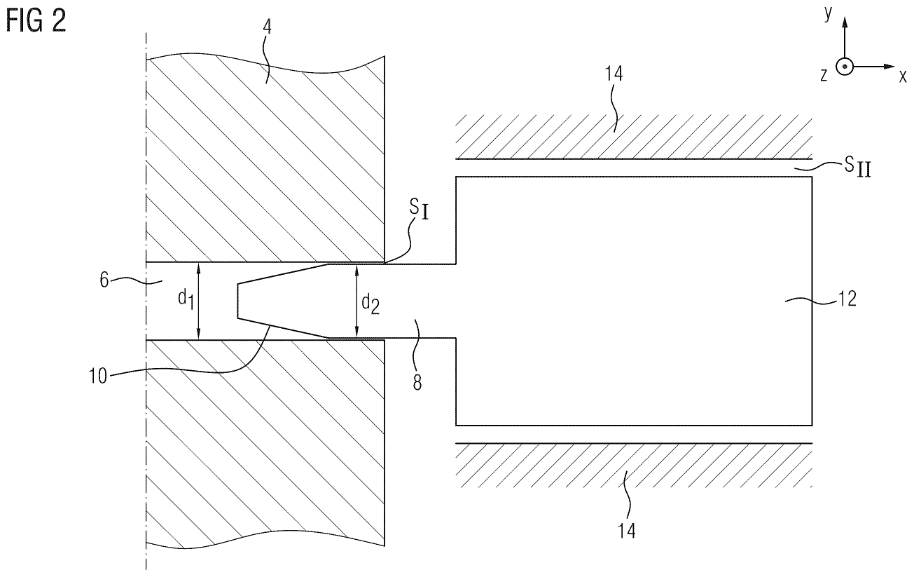

FIG. 2 in contrast illustrates an improved locking mechanism 2 which balances out or at least significantly balances out such tilting between the joining elements 4, FE.

Features corresponding to one another are identified by identical reference signs, and therefore reference is made to the above description and only points of differentiation will be discussed below.

The locking mechanism 2 according to FIG. 2 balances out positioning and/or alignment inaccuracies between the joining elements FE, 4 by means of a degree of freedom of movement outside a form-fitting region between the form-fitting element FE and the lockable element 4 and transversely to the axial stroke movement of the form-fitting element FE. FIG. 2 shows an illustration without tilting.

The form-fitting element FE has a first form-fitting element portion 8 which can be joined for the form fit which is tapered in the region of its free end or has a tapering 10 as well as a second form-fitting element portion 12 which adjoins thereto and which is wider in comparison with the first form-fitting element portion 8.

In contrast to FIG. 1, the play S₁ between the form-fitting element FE and the recess 6 is significantly smaller so that their dimensions (or their diameters d₁, d₂ in the case of the above configurations cited by way of example which are circular in relation to the respective cross-sections) are comparatively close or are significantly closer to one another. A play S_{II} between the form-fitting element portion 12 and an associated stop 14 of the locking actuator is also shown.

This play S_{II} enables the above-mentioned degree of freedom of movement of the locking mechanism outside the stated form-fitting region via which the form-fitting element FE can move transversally to its axial stroke movement and up to the stated stop 14.

In the case of a corresponding configuration of the play Su, the dimensions of the first form-fitting element portion 8 and the recess 6 (or its diameter d₁, d₂) can be very close to one another so that the form-fitting element portion 8 and the recess 6 represent a clearance fit with, for example, small to noticeable play. The description “small to noticeable play” is known to the person skilled in the art and is therefore not described in greater detail.

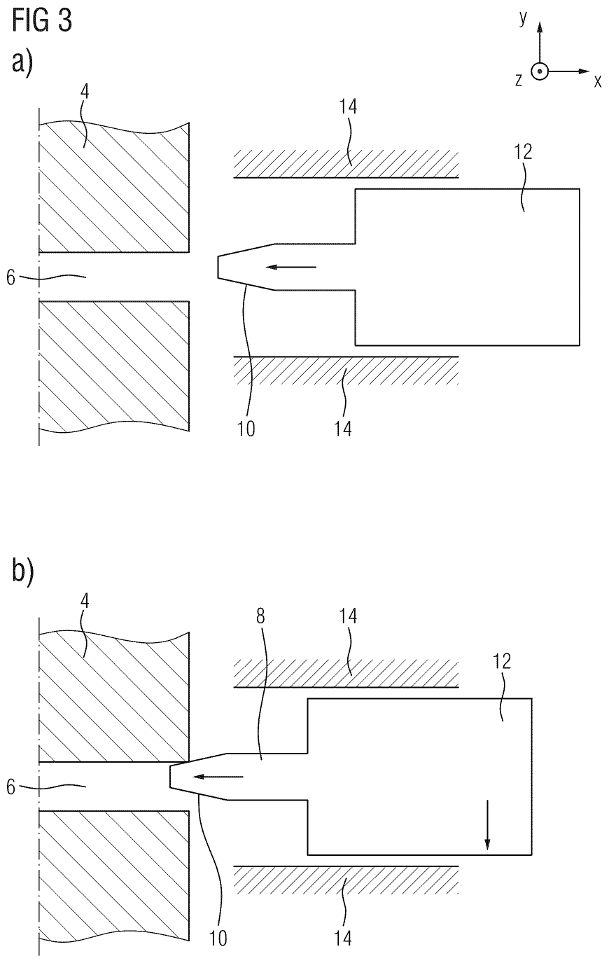

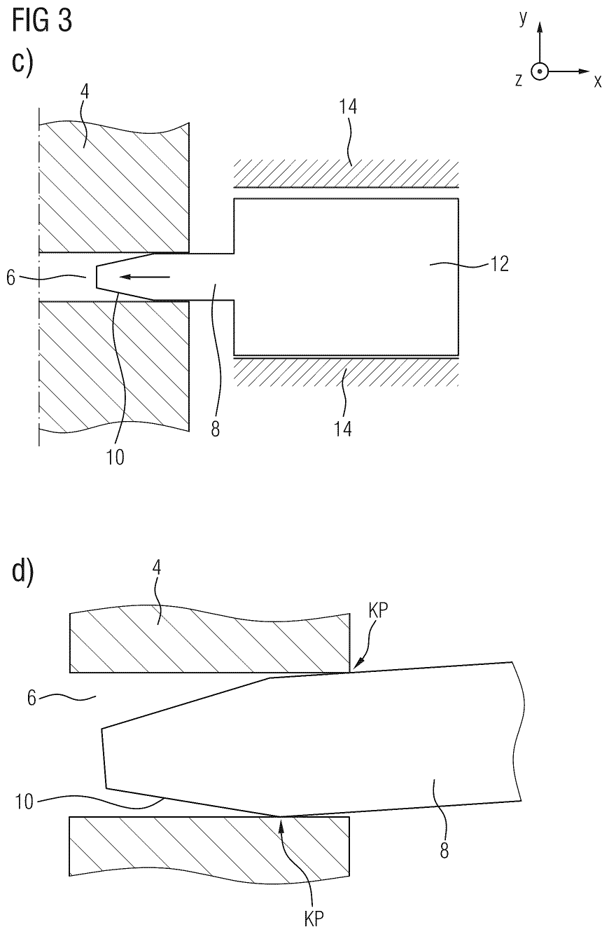

FIG. 3 illustrates an actuator-side balancing movement of the proposed locking mechanism in the case of which a form-fitting element FE of a locking actuator is arranged transversely—or in the illustrated case even orthogonally—to a lockable shaft 4 (see FIGS. 3a) to 3c)). By virtue of the fact that the tapering 10 of the form-fitting element portion 8 interacts with the hole 6 of the shaft 4, the form-fitting element portion 12—and thus the form-fitting element FE—are deflected in the direction of the assigned stop 14, i.e. transversely—or in this example orthogonally—to the axial stroke movement of the form-fitting element FE and thereby maximally up to the stop 14.

Relative to the stop 14, this balancing movement or deflection of the form-fitting element FE is a translational or linear movement, and indeed transversely or in the transverse direction Y-Y to the stated axial stroke movement of the form-fitting element FE in the X-X direction.

Relative to the hole 6, however, this balancing movement or deflection of the form-fitting element FE is a translational or linear movement in both the longitudinal direction X-X and the transverse direction Y-Y. There is, however, also a pivoting or pivoting movement with respect to the hole 6 (or relative to the Z-Z direction shown).

FIG. 3d) illustrates a tilting of a joined form-fitting element portion 8 with respect to or relative to the hole 6 which is significantly reduced in comparison with FIG. 1c). This also involves a significant reduction in the stated edge pressures KP.

FIG. 3 illustrates a tolerance position in the case of which, on the basis of the two above-mentioned tolerances (see in this regard the two plays S_{I}, S_{II} shown in FIG. 2), the stated positioning or alignment inaccuracies between the joining elements FE, 4 are balanced out.

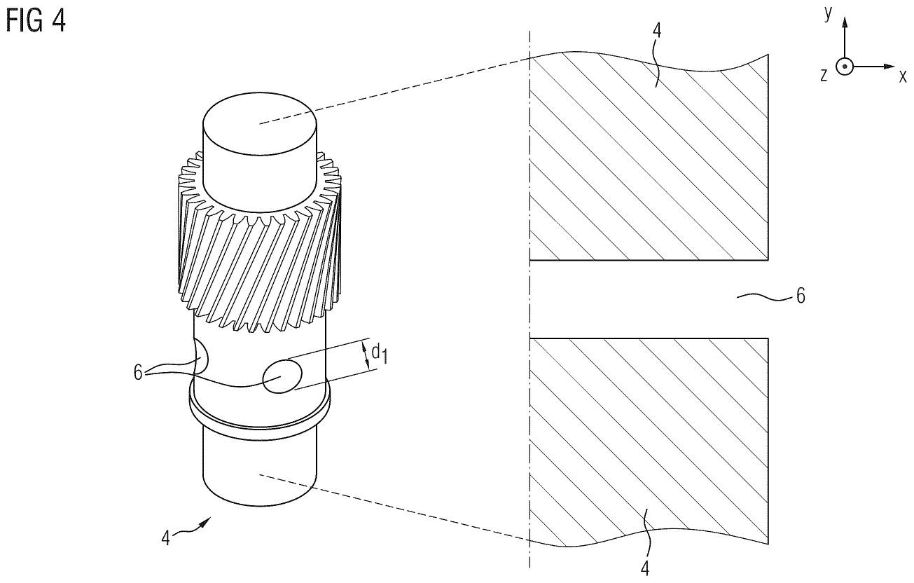

In some examples as shown in FIG. 4, a shaft 4 includes a multiplicity of holes 6 which are distributed evenly with respect to one another over the circumference of the shaft 4 and shaped radially in or on the shaft 4, into which a locking bolt FE can be moved radially with respect to the shaft 4.

In some implementations, the rotatable and lockable element is formed in the configuration of a gear wheel, in the tooth gaps of which the form-fitting element can engage. Alternatively, a correspondingly form disc with recesses or openings can also be provided. The form-fitting element can be arranged longitudinally or transversely to a longitudinal axis of the gear wheel or the disc.

Therefore, a tolerance position is provided with as little play S_{I} as possible in order to be able to generate as many recesses 6 as possible on the lockable element 4 via which a vehicle can be locked or blocked at any time in a parking position. A maximum number of holes 6 along their circumference thus arises e.g. in the case of a shaft 4 in the sense of FIG. 4.

The stop 14 illustrated schematically in FIGS. 2 and 3—outside the stated form-fitting region—can in this case represent a single stop element or a multiplicity of individual stop elements arranged—and possibly spaced apart—with respect to one another.

This stop 14 can advantageously, in accordance with the respective installation space conditions in a vehicle, be arranged or provided at a suitable point of a periphery of a drivetrain and be correspondingly spaced apart from the stated form-fitting region between the form-fitting element FE and the recess 6. This facilitates a freedom to be able to design or dimension the stop 14 in accordance with the respective installation space conditions in a vehicle in order to be able to absorb torque peaks which can arise as such. A suitable material selection for the stop 14 furthermore supports this. Moreover, in order to reduce torque peaks, the stop 14 can be combined with at least one suitable and correspondingly formed damping element and/or spring element.

Correspondingly, FIGS. 2 and 3 or the locking mechanism on which they are based open up a certain freedom of configuration in relation to the capacity to position and configure the stop 14 within a vehicle, and indeed corresponding to the respective installation space conditions in the vehicle at a suitable point of a periphery of a drivetrain.

The form-fitting element portion 8 which locks via an assigned-first-stop, which the shaft 4 forms (locking function), can absorb a static torque load acting on the locking mechanism, for example, as a result of what is known as a grade resistance which arises on a road with an incline on which a vehicle is parked.

The form-fitting element 12 in contrast can dissipate a dynamic torque load which is possibly not completely or entirely dissipated via the play S_{II} or the degree of freedom of movement up to the assigned second stop 14 by virtue of the fact that it interacts with the associated—second—stop 14 (stop function).

A dynamic torque load is understood to mean a short-term, dynamic torque load which can result, for example, if a vehicle impacts a parked vehicle. In such an event, a force acting externally on the vehicle generates such a short-term, dynamic torque in the drivetrain of the motor vehicle.

In the case of the locking mechanism according to FIG. 1, however, the form-fitting element FE absorbs both static and dynamic torque loads which arise in a drivetrain in the stated form-fitting region via the assigned stop which forms the shaft 4.

In the case of the locking mechanism proposed according to FIGS. 2 and 3, dynamic load peaks in the form of torque peaks, as described above, which are expressed in relation to the locking actuator and its form-fitting FE in the form of impact loads, are ideally entirely absorbed via the stated play S_{II}.

Dynamic torque loads which are possibly not completely or entirely dissipated via the stated play S_{II} (or the degree of freedom of movement) are thus dissipated by virtue of the fact that the second form-fitting element element portion 12 interacts with the stop 14 or hits against it. In this case, the stop 14 conducts such differential or residual loads at a suitable point into a periphery of a drivetrain, in particular of a vehicle.

Even if the ideal case described above does not arise, in contrast to FIG. 1, impact loads which act on the stated form-fitting region of the locking mechanism are at least significantly reduced and displaced corresponding to the stop 14 for absorption by the stated periphery.

Although, in the preceding description, exemplary embodiments are explained, it may be noted that a large number of modifications are possible. It should be noted, furthermore, that the exemplary embodiments are merely examples which are in no way intended to limit the scope of protection, the applications, and the structure. Instead, the above description gives a person skilled in the art a guideline for the implementation of at least one exemplary embodiment, wherein various changes may be made, especially with regard to the function and arrangement of the component parts described, without departing from the scope of protection as apparent from the claims and combinations of features equivalent thereto.

What is claimed is:

1. A locking mechanism for a vehicle, the locking mechanism comprising:
a locking actuator;
a rotatable lockable element with at least one recess,
an actuable form-fitting element of the locking actuator is movable between the locking actuator and the element in the recess in an axial stroke movement in portions in a form-fitting manner, in order to lock the element,
wherein the locking actuator has, outside a form-fitting region between the form-fitting element and the lockable element, a degree of freedom of movement for the form-fitting element transverse to the axial stroke movement of the form-fitting element as well as up to an assigned stop, up to which the form-fitting element is deflected during a locking process and after an end of the locking process, in order to on one hand balance out positioning inaccuracies between the form-fitting element and the recess during the locking process and on the other hand to dissipate dynamic torque loads of a drivetrain during the locking process and in particular after the end of the locking process.

2. The locking mechanism of claim 1, wherein the form-fitting element has a first form-fitting element portion, which is joined for the form fit, with a tapering in the region of its free end as well as a second form-fitting element portion which is wider in comparison with the first form-fitting element portion and longitudinally to the form-fitting element and which, if the tapering interacts with the recess, is deflected transversely to the axial stroke movement, and indeed within play between the second form-fitting element portion and a stop of the locking actuator and up to against the stop.

3. The locking mechanism of claim 1, wherein the form-fitting element is deflected against the stop acting counter to at least one spring.

4. The locking mechanism of claim 1, wherein a stop is supported on a housing of a drive unit.

5. The locking mechanism of claim 4, wherein the stop is supported on a housing portion of an electric motor housing or a (reduction) gear housing.

6. The locking mechanism of claim 1, wherein the form-fitting element is electrically actuable.

7. A parking lock with a locking mechanism as claimed claim 1.

8. A vehicle having a parking lock of claim 7.
